(19) United States
(12) Patent Application Publication
(10) Pub. No.: US 2002/0004717 A1
(43) Pub. Date: Jan. 10, 2002

(54) Transmitter for transmitting a signal encoded in a narrow band, and receiver for extending the band of the signal at the receiving end

(76) Inventor: Gilles Miet, Le Mans (FR)

Correspondence Address: U.S. Philips Corporation, 580 White Plains Road, Tarrytown, NY, 10591, US

(21) Appl. No.: 09/861,930

(22) Filed: May 21, 2001

(30) Foreign Application Priority Data
May 26, 2000 (EP) 00401495.7

(51) Int. Cl. G10L 19/14; G10L 21/00

(52) U.S. Cl. 704/225

(57) ABSTRACT

The invention relates to the transmission and reception of encoded narrow-band signals. At the transmitting end, the signal to be transmitted is encoded in a band which is narrower than that of the original signal, and at the receiving end this signal is decoded so as to restore the contents of the transmitted message. After decoding, the spectral band of a received signal is extended so as to improve the audio quality of the signal at the receiving end. At the transmitting end, the analysis means are provided for extracting characteristic parameters from the original signal, which parameters are not comprised in the signal encoded in the narrow band. Information comprising these parameters is transmitted in addition to the narrow-band encoded signal. At the receiving end, this information is used for reconstructing a wide-band signal from the signal received in the narrow band and from the received information. Application: digital telecommunication, mobile radiotelephony.

The invention relates to the transmission and reception of speech signals, particularly for telecommunication systems in which the spectrum width of the transmitted signal is limited.

The invention finds numerous applications, notably in mobile radiotelephony systems for improving the quality of the speech signal at the receiving end.

These systems generally involve an encoding of the source for reducing the quantity of information to be transmitted and thus increasing the capacity of the transmission channel. The source encoding, which is speech encoding in the case of telephonic transmissions, is often related to a reduction of the spectrum of the message to be transmitted. This reduction of the spectrum is generally accompanied by a diminution of the audio quality of the signal at the receiving end. To remedy this problem, various methods, referred to as spectrum extension, have been elaborated for extending the spectral band of the received signal at the receiving end.

One of these methods is described in U.S. Pat. No. 5,581,652. It relates to a method of reconstructing a wide-band speech signal from a speech signal received in a band having a narrower spectrum. The method comprises the use of a pair of interrelated speech dictionaries. A first dictionary is used for analyzing the received speech signal with the aid of a first series of vectorial codes having a narrower spectral band than the band of the original signal before transmission. A second dictionary allows extension of the spectral band of the received signal by assigning to it a second series of vectorial codes in a larger band and corresponding to the codes analyzed in the narrow band.

These methods allow a posteriori reconstruction of a wide-band signal by means of transmitted single information in the signal encoded in the narrow band by possibly using, for certain information, prediction techniques for predicting the behavior of the wide-band signal on the basis of the received signal.

It is an object of the invention to improve the performance of these methods without significantly increasing the quantity of transmitted data. To this end, the invention provides a transmitter, a receiver, a system, a transmission method and a reception method in which information representative of the original speech signal which is not comprised in the signal encoded in the narrow band is transmitted in addition to the encoded signal so as to facilitate its reconstruction at the receiving end on the basis of the signal received in the narrow band.

In accordance with a first characteristic feature of the invention, the spectral band of the original signal comprises a sub-band of high frequencies having a given gain, and the transmitted speech information represents a ratio between the gain of the original speech signal in said sub-band and the gain of the signal encoded in the narrow band.

These and other aspects of the invention are apparent from and will be elucidated, by way of non-limitative example, with reference to the embodiments described hereinafter.

In the drawings:

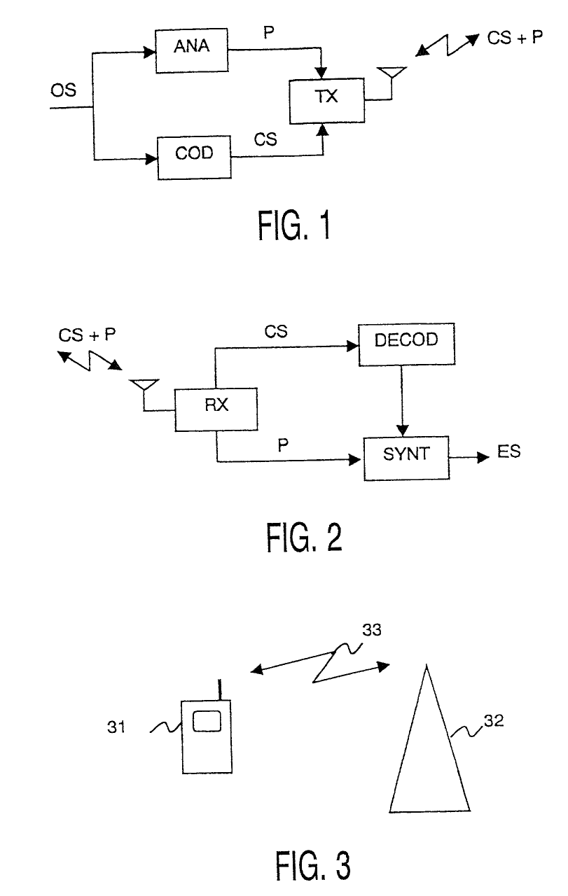

FIG. 1 is a principal circuit diagram showing a transmitter according to the invention.

FIG. 2 is a principal circuit diagram showing a receiver according to the invention.

FIG. 3 is a diagram illustrating an embodiment of the system according to the invention.

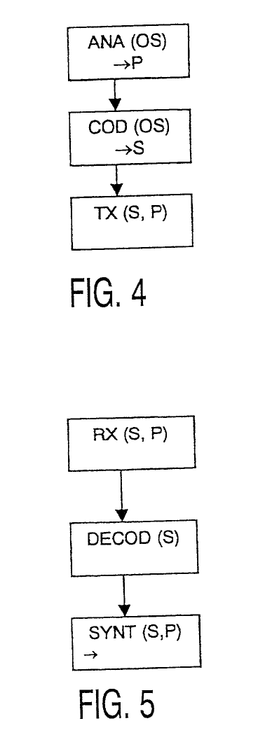

FIGS. 4 and 5 are flow charts illustrating a transmission method and a reception method, respectively, according to the invention.

Embodiments of a transmitter and a receiver according to the invention are shown in FIGS. 1 and 2, respectively. They are provided to transmit and receive, respectively, a speech signal, referred to as original signal, having a given spectral band, referred to as original band.

The transmitter shown in FIG. 1 comprises:

an analysis module ANA for analyzing an original speech signal OS and for deriving information, denoted P, which is representative of at least a characteristic speech parameter of the speech signal OS in the original band,

a speech encoding module COD (speech encoder) for encoding the original speech signal OS with a view to its transmission in a spectral band, referred to as narrow band, which is narrower than the original spectral band, and for obtaining a signal CS encoded in the narrow band, representing the original signal,

transmission means TX for transmitting the encoded speech signal CS in the narrow band and for transmitting the information P which is representative of said speech parameter in addition to the speech signal CS encoded in the narrow band.

The receiver shown in FIG. 2 comprises:

receiving means RX for receiving information P which is representative of the speech parameter, as well as the encoded speech signal CS transmitted, for example, by means of the transmitter shown in FIG. 1, the encoded speech signal having a spectral band which is narrower than the band of the original signal,

a speech decoding module DECOD for decoding the received narrow-band signal CS,

a synthesis module SYNT for reconstituting, on the basis of the received decoded speech signal and the supplementary information P, a wide-band speech signal ES having a spectral band which is extended with respect to the narrow band.

The transmission means TX and the reception means RX may comprise means for encoding and decoding the respective channel so as to protect the data during transmission. The emitter comprises, before the speech encoder COD, conventional sampling and filtering means (not shown), for example, as recommended by the ITU-T standard and particularly parts G.711 and G.712 for transforming the original signal into a digital signal OS. The signal OS in FIG. 1 is therefore already digitized.

At the receiving end, the synthesis of the wide-band speech signal by means of the block SYNT may be realized, for example, by known means of the type described in the above-mentioned document while duly taking into account the directly transmitted supplementary information P which is representative of the speech parameter.

At the receiving and transmitting ends, all the algorithms of the invention may be realized by means of a digital signal processor DSP.

FIG. 3 shows an embodiment of the system according to the invention principally constituted by a radiotelephone 31, a radio base station 32 and an air transmission channel 33, the assembly illustrating a descending radio transmission between the radio base station 32 and the radiotelephone 31. The radio base station 32 comprises a transmitter of the type shown in FIG. 1 and the radiotelephone 31 comprises a receiver of the type shown in FIG. 2. In the case of an ascending transmission between the radiotelephone and the radio base station, the radiotelephone 31 may comprise a transmitter as shown in FIG. 1 and the radio base station may comprise a receiver as shown in FIG. 2. The receiver may also be present in another radiotelephone (not shown) which is used as a destination for the message sent by the radiotelephone 31. Such a system allows extension, at the receiving end, of the spectral band of an encoded speech signal transmitted in a narrower band than the band of the original signal. This extension of the spectrum, effected before restitution of the speech signal to a user, improves the quality of the received signal. Such a system is particularly advantageous in the field of mobile radiotelephony where the available frequency spectrum is limited. The invention is also advantageous in all multiple access telecommunication systems in which the passband is shared by all users of the system.

In these systems, a speech encoding is indeed generally effected for reducing the spectral band of the signal to be transmitted so as to increase the capacity of the transmission channel. One consequence of this spectrum-reducing encoding is that it suppresses a part of the audible frequencies of the transmitted signal. This suppression has a detrimental influence on the audio quality of the signal perceived by a user at the receiving end.

To remedy this problem, various methods such as the afore-mentioned methods known as band extension or spectrum extension methods have been worked out for extending the spectral band of the received signal at the receiving end so as to improve the audio quality of the signal. One of these known methods may be particularly used in the operation of extending the band by means of the synthesis block SYNT shown in FIG. 2 for reconstituting a wide-band signal on the basis of the received narrow-band signal. However, in addition to the use of one of these methods, the invention provides the use of information which is representative of a speech parameter extracted from the original signal so as to improve the quality of the message reconstituted from the encoded signal received in the narrow band.

An advantage of the system of FIG. 3 is that it allows improvement of the quality of the received signal without substantially increasing the quantity of data transmitted through the transmission channel. By way of practical example, for a system of the GSM type (Global System for Mobile communications) functioning in accordance with a full-rate encoding at about 13 kbit/s, the invention may provide, for example, the rate at about 13.1 kbit/s or slightly more (about 14-16 kbit/s) in accordance with the nature and number of information components transmitted in addition to the narrow-band encoded signal. This slight improvement of the rate is negligible for the majority of current applications. For the other applications, it is a better compromise between rate and quality of reception than a wide-band encoder, which makes the invention even more interesting in this case. The increase of the rate is due to the fact that the transmission means TX situated in the transmitter transmit, in addition to the useful narrow-band signal encoded in accordance with a conventional speech encoding method, one or more information components which are representative of at least a speech parameter which is characteristic of the original signal in the original spectral band. These parameters may have been previously extracted from the signal to be transmitted by the analysis module ANA in accordance with a conventional method of analyzing the signal. As a function of the type of transmitted parameters, different conventional methods may be used. For example, in the case of the transmission of information representative of reflection coefficients of the signal, these coefficients may be extracted by means of an analysis method of the LPC type (Linear Predictive Coding). If the information transmitted represents the gain of the signal, an energy computing method will be appropriate. If the information concerns the voicing of certain frequency bands, techniques which are similar to the encoders of the MBE type (Multi Band Excitation) may be used.

The speech parameters to be transmitted are preferably chosen from speech parameters which are difficult to predict on the basis of the received signal by means of a conventional prediction method such as, for example, the prediction of a parameter by linear combination with other parameters. For example, gain parameters in the high frequency band (3400-8000 Hz) or low frequency band (100-300 Hz) may be concerned, parameters representing the shape of the signal, LPC envelope parameters or parameters representing the harmonics of the original signal.

In accordance with a preferred embodiment of the invention, information which is representative of the gain parameter in the high frequencies is transmitted by the transmitter in the form of a gain factor between the frequencies within the spectrum of the original signal (for example, 70-8000 Hz) but outside the spectrum of the encoded signal (for example, 300-3400 Hz), i.e. in the band (3400-8000 Hz) and the frequencies in the narrow band of the transmitted encoded signal (for example, 300-3400 Hz). This gain factor is computed by computing means which may be comprised in the analysis means ANA. It may be previously encoded before its transmission by adapted encoding means possibly comprised in the transmission means TX. FIGS. 4 and 5 are simplified flow charts of embodiments of the transmission method and an adapted reception method according to the invention, which can be carried out by a transmitter and a receiver as shown in FIGS. 1 and 2, respectively.

The transmission method comprises:

an analysis step ANA(OS) for analyzing the original speech signal OS for extracting at least information which is representative of a speech parameter P characteristic of the original speech signal OS in its original spectral band,

a speech encoding step COD(OS) for encoding the original speech signal OS with a view to its transmission in a spectral band, referred to as narrow band, which is narrower than the spectral band of the original signal, the resultant signal being denoted S,

a transmission step TX(S,P) for transmitting said speech signal encoded in the narrow band and for transmitting the supplementary information P, which is representative of said speech parameter, in addition to the speech signal encoded in the narrow band.

The method of extending the band at the receiving end comprises:

a reception step RX(S,P) for receiving the supplementary information P, which is representative of the speech signal, and for receiving the encoded speech signal S on the basis of an original speech signal having a spectral band, referred to as original band, the encoded signal having a spectral band which is narrower than the original band, referred to as narrow band,

a speech decoding step DECOD(S) for decoding the received narrow-band speech signal S,

a synthesis step SYNT(S,P) for reconstituting, on the basis of the received narrow-band speech signal S and the received supplementary information P, a wide-band speech signal having a spectral band which is larger than the narrow band.

The use of the algorithm describing the reception process necessitates a previous learning phase in which a database of narrow-band speech signals and similar wide-band signals is realized. This database allows determination of the speech parameters by which a wide-band signal can be obtained in a reliable manner from a narrow-band speech signal. This determination may take into account the speech parameters which are not easily or effectively predictable from the narrow-band signal. Certain parameters are partially predictable. The non-predictable parts may be transmitted. In this case, the learning phase is realized in the predicted part by taking the transmitted part into account. For example, if the gain ratio between the high frequencies and the frequencies of the narrow band is transmitted, the learning phase for the high frequencies is effected on the basis of the standard energy of the high band. More details about the learning phase are described in the article “More Natural Sounding Voice Quality Over the Telephone” by Masanobu Abe and Yki Yoshida, NNT Review, vol.7, no.3 , May 1995.

1. A transmitter for transmitting an original speech signal having an original spectral band, the transmitter comprising:
a module for analyzing the original speech signal and for deriving at least information which is representative of at least a speech parameter which is characteristic of the speech signal in the original band,
a module for encoding the original speech signal with a view to its transmission in a spectral band, referred to as narrow band, which is narrower than the spectral band of the original signal,
means for transmitting said speech signal encoded in the narrow band, and for transmitting said information in addition to the narrow-band encoded signal.

2. A transmitter as claimed in claim 1, in which the spectral band of the original signal comprises a sub-band of high frequencies having a given gain, characterized in that said speech parameter represents the gain of the original speech signal in said sub-band.

3. A transmitter as claimed in claim 2, in which the supplementary information which is representative of said speech parameter is a gain factor of the speech signal between the sub-band of high frequencies and the narrow band.

4. A transmitter as claimed in claim 2, in which the original band is situated in the band of 70-8000 Hz, the narrow band is situated in the band of 300-3400 Hz and the sub-band of high frequencies is situated in the band of 3400-8000 Hz.

5. A receiver for receiving a speech signal, the receiver comprising:
means for receiving a speech signal encoded on the basis of an original speech signal having a spectral band, referred to as original band, the encoded speech signal having a spectral band which is narrower than the original band, and for receiving the information, which is representative of the speech parameter, to be supplied to synthesis means,
module for decoding the received speech signal,
a synthesis module for reconstituting, on the basis of the received speech signal and information which is representative of at least a speech parameter which is characteristic of the original speech signal, a wide-band speech signal having a spectral band which is extended with respect to the narrow band.

6. A telecommunication system for transmitting a speech signal between a transmitter and a receiver, characterized in that it comprises a transmitter as claimed in claim 1 and a receiver as claimed in claim 5.

7. A method of transmitting an original speech signal having a given spectral band, referred to as original band, the method comprising:
a step of analyzing the original speech signal for deriving at least information which is representative of a speech parameter which is characteristic of the speech signal in the original band,
a step of encoding the original speech signal with a view to its transmission in a spectral band, referred to as narrow band, which is narrower than the spectral band of the original signal,
a step of transmitting said speech signal encoded in the narrow band and also transmitting said information in addition to the narrow-band encoded speech signal.

8. A computer program product for a transmitter as claimed in claim 1, the product comprising software code portions which, once loaded into the transmitter, enable it to perform the steps of the method as claimed in claim 7.

9. A method of extending the band at the receiving end, the method comprising:
a step of receiving a speech signal encoded on the basis of an original speech signal having a spectral band, referred to as original band, the encoded signal having a spectral band which is narrower than the original band, referred to as narrow band, and receiving information which is representative of the speech parameter with a view to its use in a synthesis step,
a step of decoding the received speech signal,
a synthesis step for reconstituting, on the basis of the speech signal received in the narrow band and information which is representative of at least a speech parameter which is characteristic of the original speech signal, a wide-band speech signal having a spectral band which is larger than the narrow band.

10. A method as claimed in claim 9, in which a learning step is provided for realizing a database of received narrow-band signals and wide-band signals reconstituted from said received signals, as a function of the transmitted speech parameter, the database serving to establish influence of the transmitted speech parameters on a predetermined quality factor of the reconstituted, wide-band speech signal.

11. A computer program product for a receiver as claimed in claim 5, the product comprising software code portions which, once loaded into the receiver, enable it to perform the steps of the method as claimed in claim 9.

12. A speech signal to be transmitted elaborated from an original speech signal having an original spectral band characterized in that:
it has a narrow band which is narrower than the original spectrum band
it comprises information which is representative of a speech parameter which is characteristic of the speech signal in the original signal
